(19) United States
(12) Patent Application Publication
(10) Pub. No.: US 2026/0201220 A1
(43) Pub. Date: Jul. 16, 2026

(54) ANTISTATIC PRESSURE SENSITIVE ADHESIVE

(71) Applicant: 3M INNOVATIVE PROPERTIES COMPANY, Saint Paul, MN (US)

(72) Inventors: Xiaowen LIN, Shanghai (CN); Qing YANG, Shanghai (CN); Huijie XIE, Shanghai (CN); Zhi Ping LIU

(21) Appl. No.: 19/137,943

(22) PCT Filed: Dec. 11, 2023
(86) PCT No.: PCT/IB2023/062508

§ 371 Date: Jun. 11, 2025

Related U.S. Application Data
(60) Provisional application No. 63/433,900, filed on Dec. 20, 2022.

(51) Int. Cl. C09J 133/26; B32B 7/12; B32B 17/10; C08F 220/18; C08K 5/43; C09J 5/00; C09J 11/06

(52) U.S. Cl. CPC C09J 133/26; B32B 7/12; B32B 17/10; C08F 220/1808; C09J 5/00; C09J 11/06; B32B 2250/02; B32B 2307/412; C08F 2800/20; C08F 2810/20; C08K 5/43

(57) ABSTRACT

An antistatic pressure sensitive adhesive composition, useful in electronic and optical display applications, comprising an antistatic agent and a first block copolymer comprising at least two hard A block polymeric units each independently having a Tg of at least 50° C., and at least one soft B block (meth)acrylic polymeric unit having a Tg no greater than 20° C. The composition can comprise a second block copolymer. Articles comprising an antistatic pressure sensitive adhesive composition adjacent a first surface of a substrate.

### SUMMARY

Disclosed herein are antistatic pressure sensitive adhesives, laminate articles prepared with the antistatic pressure sensitive adhesives, and methods for preparing adhesive articles. In some embodiments, the antistatic pressure sensitive adhesive comprises a (meth)acrylate-based optically clear pressure sensitive adhesive matrix that is the product of a reaction mixture and at least one antistatic agent. The reaction mixture comprises at least one alkyl (meth)acrylate, wherein the alkyl group has 4 to 18 carbon atoms, at least one hydrophilic copolymerizable monomer, at least one crosslinking monomer, at least one photo-activated crosslinker, and a free-radical generating initiator. The antistatic pressure sensitive adhesive is optically clear having a visible light transmission of at least 90% and a haze of less than 1%, has a 180° Peel Adhesion on glass of at least 0.77 N/mm, and a Surface Resistance of from 10⁸-10¹⁰ ohms/cm².

Also disclosed are laminate articles. In some embodiments, the laminate articles comprise a first substrate, a second substrate, and an antistatic pressure sensitive adhesive disposed between the first and second substrates. The antistatic pressure sensitive adhesive is described above.

Also disclosed are methods of preparing adhesive articles. In some embodiments, the method comprises providing a first substrate with a first major surface and a second major surface, providing a second substrate with a first major surface and a second major surface, and preparing an antistatic pressure sensitive adhesive or a pressure sensitive adhesive precursor mixture, disposing the antistatic pressure sensitive adhesive or pressure sensitive adhesive precursor mixture on at least a portion of the second major surface of the first substrate to form an adhesive layer, and disposing the second substrate on the adhesive layer. If the adhesive layer comprises an adhesive precursor mixture, the method further comprises curing the adhesive precursor mixture prior to disposing the second substrate on the adhesive layer. The adhesive layer comprises the antistatic pressure sensitive adhesive layer described above.

### DETAILED DESCRIPTION

A wide range of optical articles have multiple layers. The multiple layers often are adhered to each other with adhesive layers. These adhesive layers have a wide range of desired or required properties. Besides the mechanical property of adhesion, adhesives typically have other desirable properties such as optical or electric properties. Achieving a range of properties is very complex process, because often imparting one property to the adhesive layer causes detrimental effects to other properties.

An example of new classes of adhesives that have been developed to provide desirable properties are optical clear adhesives (OCAs). A range of optically clear adhesives have been developed for use in optical articles. These adhesives have the desirable combination of adhesive properties and optical properties that enable their use in a wide range of optical articles. As the use of these adhesives has increased it has become apparent that it is desirable for these adhesives to have additional properties. However, these new properties cannot be achieved by sacrificing the adhesive or optical properties.

Among the newly desired properties are electrical properties. For example, adhesive layers that are anti-static or static dissipative are desirable. Many articles, particularly multi-layer articles can have static build up on surfaces. This static build up can have adverse effects. In display devices, the static build up can cause a color shift in the transmitted light giving it a greenish tint. Therefore, there is a need for optically clear adhesives that are anti-static and yet retain their high optical clarity.

In this disclosure adhesive are described that comprise a (meth)acrylate-based optically clear pressure sensitive adhesive and at least one antistatic agent to form an anti-static pressure sensitive adhesive. This pressure sensitive adhesive has desirable optical properties such as visible light transmission of at least 90% and a haze of less than 1%, has desirable adhesive properties such as a 180° Peel Adhesion on glass of at least 0.77 N/mm, and the desirable anti-static property of a Surface Resistance of from 10⁸-10¹⁰ ohms/cm².

Also disclosed are laminate articles that comprise a first substrate, a second substrate, and an antistatic pressure sensitive adhesive disposed between the first and second substrates. This antistatic pressure sensitive adhesive is the adhesive described above.

The term “adhesive” as used herein refers to polymeric compositions useful to adhere together two adherends. Examples of adhesives are pressure sensitive adhesives.

Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process.

The term “(meth)acrylate-based” when referring to a polymer means that the polymer contains at least (meth)acrylate monomers but can contain other co-polymerizable monomers. Typically, (meth)acrylate-based polymers contain primarily (meth)acrylate monomers, i.e. contain at least 50% (meth)acrylate monomers by weight. The term “(meth)acrylate” refers to monomeric acrylic or methacrylic esters of alcohols. Acrylate and methacrylate monomers or oligomers are referred to collectively herein as “(meth)acrylates”.

The terms “room temperature” and “ambient temperature” are used interchangeably to mean temperatures in the range of 20° C. to 25° C.

The terms “Tg” and “glass transition temperature” are used interchangeably. If measured, Tg values are determined by Differential Scanning calorimetry (DSC) at a scan rate of 10° C./minute, unless otherwise indicated. Typically, Tg values for copolymers are not measured but are calculated using the well-known Fox Equation, using the monomer Tg values provided by the monomer supplier, as is understood by one of skill in the art.

The term “adjacent” as used herein when referring to two layers means that the two layers are in proximity with one another with no intervening open space between them. They may be in direct contact with one another (e.g. laminated together) or there may be intervening layers.

The terms “polymer” and “macromolecule” are used herein consistent with their common usage in chemistry. Polymers and macromolecules are composed of many repeated subunits. As used herein, the term “macromolecule” is used to describe a group attached to a monomer that has multiple repeating units. The term “polymer” is used to describe the resultant material formed from a polymerization reaction.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “aryl” refers to a monovalent group that is aromatic and carbocyclic. The aryl can have one to five rings that are connected to or fused to the aromatic ring. The other ring structures can be aromatic, non-aromatic, or combinations thereof. Examples of aryl groups include, but are not limited to, phenyl, biphenyl, terphenyl, anthryl, naphthyl, acenaphthyl, anthraquinonyl, phenanthryl, anthracenyl, pyrenyl, perylenyl, and fluorenyl.

The terms “free radically polymerizable” and “ethylenically unsaturated” are used interchangeably and refer to a reactive group which contains a carbon-carbon double bond which is able to be polymerized via a free radical polymerization mechanism.

Unless otherwise indicated, the terms “optically transparent”, and “visible light transmissive” are used interchangeably, and refer to an article, film or adhesive that has a high light transmittance over at least a portion of the visible light spectrum (about 400 to about 700 nm). Typically, optically transparent articles have a visible light transmittance of at least 90% and a haze of less than 10%.

Unless otherwise indicated, “optically clear” refers to an adhesive or article that has a high light transmittance over at least a portion of the visible light spectrum (about 400 to about 700 nm), and that exhibits low haze, typically less than about 5%, or even less than about 2%. In some embodiments, optically clear articles exhibit a haze of less than 1% at a thickness of 50 micrometers or even 0.5% at a thickness of 50 micrometers. Typically, optically clear articles have a visible light transmittance of at least 90%, often higher such as 95%, 97%, 98% or even 99% or higher.

Disclosed herein are antistatic pressure sensitive adhesives. The antistatic pressure sensitive adhesives comprise a (meth)acrylate-based optically clear pressure sensitive adhesive matrix and at least one antistatic agent. The antistatic pressure sensitive adhesive has desirable optical properties such as visible light transmission of at least 90% and a haze of less than 1%, has desirable adhesive properties such as a 180° Peel Adhesion on glass of at least 0.77 N/mm, and the desirable anti-static property of a Surface Resistance of from 10⁸-10¹⁰ ohms/cm².

The antistatic pressure sensitive adhesive comprises a (meth)acrylate-based optically clear pressure sensitive adhesive matrix. The (meth)acrylate-based pressures sensitive adhesive matrix is the product of a reaction mixture comprising: at least one alkyl (meth)acrylate, wherein the alkyl group has 4 to 18 carbon atoms; at least one hydrophilic copolymerizable monomer; at least one crosslinking monomer; at least one photo-activated crosslinker; and a free-radical generating initiator. Each of these components is described in greater detail below.

The reaction mixture that forms the pressure sensitive adhesive matrix comprise at least one alkyl (meth)acrylate monomers with 4 to 18 carbon atoms. A wide range of alkyl (meth)acrylate monomers are suitable. Examples of suitable monomers include linear or branched monofunctional acrylates or methacrylates of non-tertiary alkyl alcohols, the alkyl groups of which have from 4 to 18 carbon atoms, in some embodiments, from 4 to 12 carbon atoms. Examples of suitable monomers include, but are not limited to: 2-ethylhexyl (meth)acrylate, pentyl (meth)acrylate, n-octyl (meth)acrylate, isooctyl (meth)acrylate, isononyl (meth)acrylate, n-butyl (meth)acrylate, isobutyl (meth)acrylate, hexyl (meth)acrylate, n-nonyl (meth)acrylate, isoamyl (meth)acrylate, n-decyl (meth)acrylate, isodecyl (meth)acrylate, dodecyl (meth)acrylate, isobornyl (meth)acrylate, cyclohexyl (meth)acrylate, phenyl meth (acrylate), benzyl meth (acrylate), isostearylacrylate and 2-methylbutyl (meth)acrylate, and combinations thereof. Particularly suitable alkyl (meth)acrylate monomer(s) comprise: 2-ethylhexyl (meth)acrylate, isobornyl (meth)acrylate, iso-octyl (meth)acrylate, butyl (meth)acrylate, and mixtures thereof.

The reaction mixture that forms the pressure sensitive adhesive matrix also comprises at least one hydrophilic copolymerizable monomer. Examples of suitable hydrophilic copolymerizable monomers include, but are not limited to: acrylic acid (AA), methacrylic acid, itaconic acid, fumaric acid, methacrylamide, N-alkyl substituted and N,N-dialkyl substituted acrylamides or methacrylamides where the alkyl group has up to 3 carbons, 2-hydroxyethyl acrylate (HEA), and 2-hydroxy-propyl acrylate (HPA), 4-hydroxybutylacrylate, 2-ethoxyethoxyethyl acrylate (Viscoat-190), 2-methoxyethoxyethylacrylate, acrylamide (Acm), N-morpholino acrylate (MoA), and diacetoneacrylamide. Combinations of polar monomers and the hydrophilic, hydroxyl functional monomeric compound may also be used. Combinations of these types of monomers allow for adhesive compositions with good cohesive strength due to internal hydrogen bonding between the polar monomer and the hydrophilic, hydroxyl functional monomeric compound. These compositions may also have a broadened glass transition temperature (Tg), which in turn may broaden the lamination window for the adhesive composition. Particularly suitable hydrophilic copolymerizable monomer(s) comprise: (meth)acrylic acid, 2-hydroxyethyl (meth)acrylate, hydroxypropyl (meth)acrylate, ethoxyethoxyethyl (meth)acrylate, (meth)acrylamide, diacetone (meth)acrylamide, N, N-dimethyl(meth)acrylamide, and N-morpholino (meth)acrylate, or combinations thereof.

The reaction mixture further comprises at least one crosslinking monomer. These crosslinking monomers are sometimes described as thermal crosslinkers to differentiate them from the photo-activated crosslinkers described below. Such thermal crosslinkers may include multifunctional isocyanates, aziridines, multifunctional (meth)acrylates, and epoxy compounds. Exemplary crosslinkers include difunctional acrylates such as 1,6-hexanediol diacrylate or multifunctional acrylates such as are known to those of skill in the art. Useful isocyanate crosslinkers include, for example, an aromatic diisocyanate available as DESMODUR L-75 from Bayer, Cologne, Germany.

The reaction mixture further comprises a photo-activated crosslinker; that is different from the thermal crosslinkers described above. The photo-activated crosslinkers are generally activated by Ultraviolet, or “UV” light. Such UV crosslinkers may include non-copolymerizable photocrosslinkers, such as benzophenones and copolymerizable photocrosslinkers such acrylated or methacrylate benzophenones like 4-acryloxybenzophenones (ABP).

The reaction mixtures also include at least one initiator. The initiator can be a thermal initiator or a photoinitiator. Examples of thermal initiators include peroxides such as benzoyl peroxide and its derivatives or azo compounds such as VAZO 67, available from E. I. du Pont de Nemours and Co. Wilmington, DE, which is 2,2′-azobis-(2-methylbutyronitrile), or V-601, available from Wako Specialty Chemicals, Richmond, VA, which is dimethyl-2,2′-azobisisobutyrate. A variety of peroxide or azo compounds are available that can be used to initiate thermal polymerization at a wide variety of temperatures. The precursor mixtures can include a photoinitiator. Particularly useful are initiators such as IRGACURE 651, available from BASF, Tarrytown, NY, which is 2,2-dimethoxy-2-phenylacetophenone.

The composition of the reaction mixtures to form the antistatic pressure sensitive adhesive can vary depending upon a variety of factors, such as the desired level of adhesion, the desired Tg, the desired modulus, and so forth. In some embodiments, the reaction mixture comprises:
60-95 parts by weight of alkyl (meth)acrylate monomer(s) with 4-18 carbon atoms;
5-40 parts by weight hydrophilic copolymerizable monomer(s);
0.01-0.05 parts by weight of crosslinking monomer;
1-5 parts by weight of photo-activated crosslinker; and
0.05-2 parts by weight of free-radical generating initiator.

Besides that antistatic agents that are added to the PSA matrix and are described in detail below, a variety of optional additives can be included in the antistatic pressure sensitive adhesives of this disclosure, as long as the additives do not adversely affect the desired adhesive, optical and antistatic properties. Examples of suitable additives include adhesion promoting additives, such as silanes and titanates. Such additives can promote adhesion between the adhesive and the substrates, like the glass and cellulose triacetate of an LCD by coupling to the silanol, hydroxyl, or other reactive groups in the substrate. The silanes and titanates may have only alkoxy substitution on the Si or Ti atom connected to an adhesive copolymerizable or interactive group. Alternatively, the silanes and titanates may have both alkyl and alkoxy substitution on the Si or Ti atom connected to an adhesive co-polymerizable or interactive group. An example of a suitable silane includes, but is not limited to, (3-glycidyloxypropyl) trimethoxysilane.

Other optional additives include tackifiers. Useful tackifiers include, for example, rosin ester resins, aromatic hydrocarbon resins, aliphatic hydrocarbon resins, and terpene resins. In general, light-colored tackifiers selected from hydrogenated rosin esters, terpenes, or aromatic hydrocarbon resins can be used. Other materials can be added for special purposes, including, for example, oils, plasticizers, antioxidants, UV stabilizers, pigments, curing agents, polymer additives, and other additives provided that they do not significantly reduce the optical clarity of the pressure sensitive adhesive.

The antistatic pressure sensitive adhesive also comprises at least one antistatic agent. A wide range of antistatic agents are suitable as long as they do not interfere with the optical or adhesive properties of the antistatic pressure sensitive adhesive. Among the more suitable antistatic agents are quaternary alkyl ammonium sulfonimide of general formula 1:

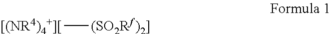

where R⁴ is an alkyl group with 1-6 carbon atoms; and R^{f} is fluorinate alkyl group with 1-4 carbon atoms. In some embodiments, the R^{f} groups are perfluorinated methyl groups.

The antistatic agent is present as an additive in the antistatic pressure sensitive adhesive, meaning that it is a minor component being present in an amount of less than 50% by weight of the total dry weight of the antistatic pressure sensitive adhesive composition. In some embodiments, the antistatic agent comprises 2-12% by weight based on the total dry weight of the antistatic pressure sensitive adhesive.

As mentioned above, the antistatic pressure sensitive adhesive has a range of desirable properties. Among these properties are desirable optical properties such as visible light transmission of at least 90% and a haze of less than 1%, has desirable adhesive properties such as a 180° Peel Adhesion on glass of at least 0.77 N/mm, and the desirable anti-static property of a Surface Resistance of from 10⁸-10¹⁰ ohms/cm².

Additionally, the antistatic pressure sensitive adhesive has other desirable measurable properties. Among these properties are desirable storage modulus (G′) and glass transition temperature (Tg). Storage modulus is a factor that relates to the internal cohesive strength of the pressure sensitive adhesive. Storage modulus can be measured by Dynamic Mechanical Analysis (DMA). Tg affects the tackiness of the pressure sensitive adhesive, typically pressure sensitive adhesives have a Tg that is less than or equal to room temperature (20° C.). Tg can be measured in a variety of ways including DMA or DSC (Differential Scanning calorimetry), but typically Tgs are not measured but are calculated. The Tg can be calculated using the well-known Fox equation using the homopolymer Tg values of the monomers as supplied by the monomer suppliers. In some embodiments, the antistatic pressure sensitive adhesive has a storage modulus (G′) of greater than 100 kilo Pascals at 25° C., and a Tg of 0° C. or lower.

Also disclosed are laminate articles. The laminate articles comprise a first substrate, a second substrate, and an antistatic pressure sensitive adhesive disposed between the first and second substrates. The antistatic pressure sensitive adhesive has been described above and comprises a (meth)acrylate-based optically clear pressure sensitive adhesive matrix and at least one antistatic agent.

A wide variety of substrates are suitable as the first and second substrates. Typically, at least one of the first and second substrates is substantially transparent. In many embodiments, both the first and second substrate or substantially transparent, or even optically clear.

The substrates may be rigid, semi-rigid or flexible. Examples of rigid substrates include plates such as glass plates, PMMA (polymethylmethacrylate) plates, or PC (polycarbonate) plates or the surface of an electronic or optical device. Examples of semi-rigid substrates include, for example, multi-layer films where the number of layers or the thickness of the layers hinder the flexibility, such as the bendability. Examples of flexible substrates include film substrates such as optical films.

Also disclosed are methods for preparing articles. In some embodiments, the method comprises providing a first substrate with a first major surface and a second major surface, providing a second substrate with a first major surface and a second major surface, preparing an antistatic pressure sensitive adhesive or an antistatic pressure sensitive adhesive precursor mixture, disposing the antistatic pressure sensitive adhesive or the antistatic pressure sensitive adhesive precursor mixture on at least a portion of the second major surface of the first substrate to form an adhesive layer, and disposing the second substrate on the adhesive layer. Examples of suitable first and second substrate are described above.

In some embodiments, an antistatic pressure sensitive adhesive is disposed on the first substrate, and the antistatic pressure sensitive adhesive comprises a pressure sensitive adhesive matrix prepared from a cured reaction mixture and at least one antistatic agent. The antistatic pressure sensitive adhesive may contain additional optional additives. The components used to form the antistatic pressure sensitive adhesive are described in detail above. In these embodiments, preparing the antistatic pressure sensitive adhesive comprises providing a reaction mixture comprising: at least one alkyl (meth)acrylate, wherein the alkyl group has 4 to 18 carbon atoms; at least one hydrophilic copolymerizable monomer; at least one crosslinking monomer; at least one photo-activated crosslinker; a free-radical generating initiator; and at least one antistatic agent; and curing the reaction mixture. The antistatic agent can be added before or after the curing reaction. The curing is carried out by activating the at least one free-radical generating initiator. This activation can be carried out either thermally or photochemically depending upon the selected free-radical generating initiator. Since the reaction mixture contains a photo-activated crosslinker, typically the reaction mixture is cured thermally or uses a photoinitiator that activates at a different wavelength than the photo-activated crosslinker to prevent photocrosslinking prior to disposing on the surface of the first substrate.

In other embodiments, an antistatic pressure sensitive adhesive precursor mixture is disposed on the surface of the first substrate. The precursor mixture comprises: at least one alkyl (meth)acrylate, wherein the alkyl group has 4 to 18 carbon atoms; at least one hydrophilic copolymerizable monomer; at least one crosslinking monomer; at least one photo-activated crosslinker; a free-radical generating initiator; and at least one antistatic agent. This precursor mixture is typically partially polymerized to increase the viscosity to form a coatable syrup and additional free radical generating initiator is added prior to disposing the precursor mixture on the surface of the first substrate. After disposing the precursor mixture onto the surface of the first substrate to form a layer, this layer is cured to form the antistatic pressure sensitive adhesive layer. Typically, this curing is carried out photochemically, and the free-radical generating initiator is a photoinitiator.

However the antistatic pressure sensitive adhesive is formed on the surface of the first substrate, in some embodiments the pressure sensitive adhesive layer may be photocrosslinked by exposure of the pressure sensitive adhesive layer to actinic radiation such as UV light. If curing of the antistatic pressure sensitive adhesive is carried out photochemically, photocrosslinking may occur during the curing step and there is no need to carry out a separate photocrosslinking step.

However prepared, the antistatic pressure sensitive adhesive layer has the desirable properties described above. The antistatic pressure sensitive adhesive layer is optically clear having a visible light transmission of at least 90% and a haze of less than 1%, has a 180° Peel Adhesion on glass of at least 0.77 N/mm, and a Surface Resistance of from 10⁸-10¹⁰ ohms/cm².

### Examples

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company; Milwaukee, Wisconsin unless otherwise noted. The following abbreviations are used: mm=millimeters; cm=centimeters; μm=micrometers; in =inch; kg=kilograms; Pa=Pascals; min=minutes; and N=Newtons. The terms “weight %”, “% by weight”, and “wt %” are used interchangeably.

Table of Abbreviations

| Abbreviation or | |
|---|---|
| Trade | |
| Designation | Description |
| 2-EHA | 2-Ethylhexyl acrylate, available from BASF |
| IBOA | Isobornyl acrylate available from SAN ESTERS CORPORATION |
| 2-HEA | 2-Hydroxyethyl Acrylate available from Yinyan, China |
| 2-EHMA | 2-Ethylhexyl methacrylate, available from Aladdin |
| ACM | Acrylamide |
| HDDA | 1.6-Hexanediol diacrylate |
| ABP | acryloyloxy benzophenone, 50% in 2-EHA |
| Initiator-1 | Available as IRGACURE 651 from Ciba |
| Silane | Epoxy silane commercially available from Dow Chemical Company as |
| | DOWSIL Z-6040 |
| Antistat-1 | Antistatic agent [N(n-C₄H₉)₃(CH₃)]⁺[N(SO₂CF₃)₂]⁻ available from 3M |
| | Company as FF4400 |
| Antistat-2 | Antistatic agent [NR₄]⁺[N(SO₂CF₃)₂]⁻ available from 3M Company as |
| | FC-5000 |
| OCA | Optically Clear Adhesives |
| NP | Functionalized nanoparticles |

### Test Methods

### Optical Property Measurements

Transmission, clarity, and haze data were acquired using a BYK Gardner Haze-Gard Plus (BYK-Gardner USA, Inc., Columbia, MD).

### Surface Resistance Measurements

Surface resistivity was tested on adhesive layers with a Trek Model 152-1 Resistance Meter with an applied voltage of 10 Volts.

### 180° Peel Adhesion

Samples of OCAs were coated onto PET films and tested for 180° Peel Adhesion from a glass adherend. Isopropyl alcohol was used to clean the adherend (glass) prior to film application. The adhesive film samples were cut into 1″ (2.54 cm) wide strips. After lamination and prior to testing, the samples were equilibrated at a room temperature, 23° C. and relative humidity of 50%, for 30 minutes. Peel adhesion was measured as a 180 degree peel back at a crosshead speed of 12 in/min using an Instron Peel Tester. The peel adhesion force is reported as an average of three replicates, in kilograms per inch and converted to Newtons/millimeter (N/mm).

### Rheology and Tg Measurement: Dynamic Mechanical Thermal Analysis (DMTA)

Using an DHR-3 rheometer (available from TA Instruments, New Castle, Delaware), DMTA testing was carried out on the PSAs using a parallel plate geometry with 8 mm diameter plates and a gap of 1 mm. Testing was conducted using a temperature scan rate of 3° C./min at a frequency of 1 Hertz and a maximum strain of 1%. The scans were performed from −20° C. to 100° C.

### Aging Conditions

The following aging conditions are used:
A. 70° C. refers to aging at 70° C. for the time specified
B. 85/85 refers to aging at 85° C. and 85% Relative Humidity for the time specified
C. TS refers to Thermal Shock, a cycling of temperature between −40° C. and 85° C., 1 hour per cycle, for the time specified
D. QUV refers to exposure of the sample to UV light for the time specified

### EXAMPLES

### Comparative Examples CE1-CE9

An OCA composition (CE1) and OCA compositions with Antistat-1 (CE2-CE4) were prepared. The adhesive formulations are shown in Table 1 in parts by weight. The components were mixed and cured by 365 nm LED (light-emitting diode) light.

The compositions described above were coated to form adhesive layers shown in Table 2. The thickness of the adhesive layers is shown in Table 2. Examples CEIA-CE6A are single layers of adhesive, Examples CE7B-CE9B are 2-layer constructions with a layer of CE1 adhesive covered with a layer of test adhesive. The samples were tested for surface resistivity and then exposed to UV radiation and retested for surface resistivity and haze. The data are shown in Table 2.

TABLE 1
Adhesive Compositions

| | 2- | 2- | 2- | | | | | Initiator- | | Antistat- |
|---|---|---|---|---|---|---|---|---|---|---|
| Ex | EHA | EHMA | HEA | IBOA | ACM | HDDA | AEBP | 1 | Silane | 1 |
| CE1 | 42 | 18 | 14.5 | 23 | 2.5 | 0.03 | 2 | 0.45 | 0.05 | 0 |
| CE2 | 42 | 18 | 14.5 | 23 | 2.5 | 0.03 | 2 | 0.45 | 0.05 | 1 |
| CE3 | 42 | 18 | 14.5 | 23 | 2.5 | 0.03 | 2 | 0.45 | 0.05 | 2 |
| CE4 | 42 | 18 | 14.5 | 23 | 2.5 | 0.03 | 2 | 0.45 | 0.05 | 4 |

TABLE 2
Adhesive Layer Testing

| | | | Surface | Surface | | |
|---|---|---|---|---|---|---|
| | | Adhesive | Resistivity | Resistivity | | |
| | | thickness | Pre UV | Post UV | UV dose | Haze |
| Ex | Composition | (μm) | (ohms/square) | (ohms/square) | (Joules) | (%) |
| CE1A | CE1 | 110 | >10 × 10¹² | >10 × 10¹² | 3 | 0.25 |
| CE2A | CE2 | 110 | 5.3 × 10⁹ | 6.3 × 10⁹ | 3 | 0.31 |
| CE3A | CE3 | 110 | 4.4 × 10⁹ | 4.7 × 10⁹ | 3 | 2.34 |
| CE4A | CE4 | 110 | 3.9 × 10⁹ | 4.5 × 10⁹ | 3.8 | 13.6 |
| CE5A | CE2 | 150 | 5.0 × 10⁹ | 6.2 × 10⁹ | 3 | 0.31 |
| CE6A | CE3 | 150 | 4.6 × 10⁹ | 5.8 × 10⁹ | 3.5 | 3.65 |
| CE7B | CE1/CE2 | 150 | 5.9 × 10⁹ | 9.4 × 10⁹ | 3 | 0.34 |
| CE8B | CE1/CE3 | 150 | 4.3 × 10⁹ | 4.8 × 10⁹ | 3.5 | 3.4 |
| CE9B | CE1/CE4 | 150 | 3.6 × 10⁹ | 4.6 × 10⁹ | 3.8 | 9.7 |

### Examples E1-E4 and Comparative Examples CE10-CE11

An OCA composition (CE10) and OCA compositions with Antistat-2 (E1-E4) were prepared. The adhesive formulations are shown in Table 3 in parts by weight. The components were mixed and cured by 365 nm LED (light-emitting diode) light.

The compositions described above were coated to form adhesive layers shown in Table 4. The thickness of the adhesive layers is shown in Table 4. Examples CE10-CE11 are single layers of adhesive, Examples CE7B-CE9B are 2-layer constructions with a layer of CE1 adhesive covered with a layer of test adhesive. The samples were tested for surface resistivity and then exposed to UV radiation and retested for surface resistivity and haze. The data are shown in Table 2.

TABLE 3
Adhesive Compositions

| | 2- | 2- | 2- | | | | | Initiator- | | Antistat- |
|---|---|---|---|---|---|---|---|---|---|---|
| Ex | EHA | EHMA | HEA | IBOA | ACM | HDDA | AEBP | 1 | Silane | 2 |
| CE10 | 42 | 18 | 14.5 | 23 | 2.5 | 0.03 | 2 | 0.45 | 0.05 | 0 |
| CE11 | 42 | 18 | 14.5 | 23 | 2.5 | 0.03 | 2 | 0.45 | 0.05 | 0 |
| E1 | 42 | 18 | 14.5 | 23 | 2.5 | 0.03 | 2 | 0.45 | 0.05 | 3 |
| E2 | 42 | 18 | 14.5 | 23 | 2.5 | 0.03 | 2 | 0.45 | 0.05 | 6 |
| E3 | 42 | 18 | 14.5 | 23 | 2.5 | 0.03 | 2 | 0.45 | 0.05 | 9 |
| E4 | 42 | 18 | 14.5 | 23 | 2.5 | 0.03 | 2 | 0.45 | 0.05 | 12 |

TABLE 4
Adhesive Layer Testing

| | | | Surface | Surface | |
|---|---|---|---|---|---|
| | | Adhesive | Resistivity | Resistivity | |
| | | thickness | Pre UV | Post UV | UV dose |
| Ex | Composition | (μm) | (ohms/square) | (ohms/square) | (Joules) |
| CE10A | CE10 | 110 | >10 × 10¹² | >10 × 10¹² | 3 |
| CE11A | CE11 | 150 | 1.7 × 10¹⁰ | 1.8 × 10¹⁰ | 3 |
| E1A | E1 | 110 | 1.5 × 10⁹ | 1.8 × 10⁹ | 3 |
| E2A | E2 | 110 | 4.6 × 10⁸ | 5.2 × 10⁸ | 3 |
| E3A | E3 | 110 | 2.8 × 10⁸ | 3.2 × 10⁸ | 3 |
| E4A | E4 | 110 | 1.8 × 10⁸ | 2.4 × 10⁸ | 3 |

### Rheological Performance and Aging

Samples of CE10A, CE11A, E2A, E4A were tested for rheological properties, both initial (0 hours) and after 800 hours and 180° Peel Adhesion to determine the impact of the addition of antistatic additive on these properties. Initial Peel-1 was measured after post-lamination with no post cure and 20 min dwell, Initial Peel-2 was measured after lamination and post cure (3 Joules of 365 nm LED light) and 20 min dwell. The results are shown in Table 5.

TABLE 5
Adhesion Aging Performance

| | Initial (0 hours) | | | | | | | |
|---|---|---|---|---|---|---|---|---|
| | | | Peel-1 | Peel-2 | 800 hours Aged Peel | | | |
| | Tg | | Kg/in | Kg/in | Adhesion Kg/in (N/mm) | | | |
| Ex. | (° C.) | G′(kPa) | (N/mm) | (N/mm) | 70° C. | 85/85 | TWS | −40° C. |
| CE10A | 2.04 | 198 | 3.56 | 2.99 | 3.81 | 3.69 | 3.87 | 3.90 |
| | | | (1.37) | (1.15) | (1.47) | (1.42) | (1.49) | (1.50) |
| CE11A | 0.28 | 181 | 4.63 | 3.26 | 3.92 | 3.90 | 4.16 | 4.21 |
| | | | (1.79) | (1.26) | (1.51) | (1.50) | 1.60) | (1.63) |
| E2A | −1.97 | 147 | 3.35 | 2.47 | 3.52 | 3.68 | 3.34 | 3.42 |
| | | | (1.29) | (0.95) | (1.36) | (1.42) | (1.29) | (1.32) |
| E4A | −5.83 | 102 | 3.22 | 2.21 | 3.21 | 3.49 | 3.25 | 3.04 |
| | | | (1.24) | (0.85) | (1.24) | (1.35) | (1.25) | (1.17) |

### Optical Performance and Aging

Samples of CE10A, E2A, E4A were tested for optical properties, both initial (0 hours) and after 800 hours aging under various conditions to determine the impact of the addition of antistatic additive on these properties. The results are shown in Table 6.

TABLE 6
Optical Aging Performance

| | O hours | | | 800 hours 85/85 | | | 800 hours TS | | | 800 hours QUV | | |
|---|---|---|---|---|---|---|---|---|---|---|---|---|
| Ex | T(%) | H(%) | b* | T(%) | H(%) | b* | T(%) | H(%) | b* | T(%) | H(%) | b* |
| CE10A | 92.3 | 0.23 | 1/06 | 90.4 | 1.34 | 1.92 | 92.0 | 0.29 | 0.63 | 91.7 | 0.29 | 1.11 |
| E2A | 92.1 | 0.17 | 0.53 | 90.2 | 1.82 | 2.71 | 91.7 | 0.16 | 0.82 | 91.6 | 0.15 | 1.01 |
| E4A | 92.0 | 0.16 | 0.52 | 89.6 | 4.05 | 1.13 | 91.4 | 0.21 | 0.83 | 91.1 | 0.15 | 1.10 |

### Examples E5-E9

A series of adhesive samples were prepared using the compositions of Table 7 in parts by weight to determine the effect of variation in crosslinking and coating process. The compositions were coated and cured to form adhesive layers, the total dose of the coating process was changed as shown in Table 8. The samples were tested for surface resistivity before and after exposure to post-curing UV radiation. The Tg and modulus were measured. These data are shown in Table 9.

TABLE 7
Adhesive Compositions

| | 2- | 2- | 2- | | | | | Initiator- | | Antistat- |
|---|---|---|---|---|---|---|---|---|---|---|
| Ex | EHA | EHMA | HEA | IBOA | ACM | HDDA | ABP | 1 | Silane | 2 |
| E5 | 42 | 18 | 14.5 | 23 | 2.5 | 0.03 | 2 | 0.55 | 0.05 | 5 |
| E6 | 42 | 18 | 14.5 | 23 | 2.5 | 0.03 | 2 | 0.55 | 0.05 | 5 |
| E7 | 42 | 18 | 14.5 | 23 | 2.5 | 0.04 | 2 | 0.45 | 0.05 | 5 |
| E8 | 42 | 18 | 14.5 | 23 | 2.5 | 0.04 | 2 | 0.45 | 0.05 | 5 |

TABLE 8
Adhesive Layer Formation

| | | Total UV dose |
|---|---|---|
| Ex | Composition | (milliJoules/cm²) |
| E5A | E5 | 754 |
| E6A | E6 | 714 |
| E7A | E7 | 754 |
| E8A | E8 | 714 |

TABLE 9
Adhesive Layer Testing

| | | Surface | Surface | | | |
|---|---|---|---|---|---|---|
| | Adhesive | Resistivity | Resistivity | | | |
| | thickness | Pre UV | Post UV | UV dose | Tg | G′ |
| Ex | (μm) | (ohms/square) | (ohms/square) | (Joules) | (° C.) | (kPa) |
| CE10A | 150 | >10 × 10¹² | >10 × 10¹² | 3 | | |
| E5A | 150 | 8.5 × 10⁸ | 9.7 × 10⁸ | 3 | −2.99 | 118 |
| E6A | 150 | 6.0 × 10⁸ | 8.2 × 10⁸ | 3 | −2.89 | 135 |
| E7A | 150 | 7.8 × 10⁸ | 9.5 × 10⁸ | 3 | −3.15 | 145 |
| E8A | 150 | 4.4 × 10⁸ | 6.8 × 10⁸ | 3 | −2.46 | 142 |

### Examples E10-E18

A series of adhesive samples were prepared using the compositions of Table 10 in parts by weight to determine the effect of variation in crosslinking and coating process. The compositions were coated and cured to form adhesive layers, the total dose of the coating process was changed as shown in Table 11. The samples were tested for surface resistivity before and after exposure to post-curing UV radiation. The Tg and modulus were measured. These data are shown in Table 12. Optical properties were measured and are shown in Table 13.

TABLE 10
Adhesive Compositions

| | 2- | 2- | 2- | | | | | Initiator- | | Antistat- |
|---|---|---|---|---|---|---|---|---|---|---|
| Ex | EHA | EHMA | HEA | IBOA | ACM | HDDA | ABP | 1 | Silane | 2 |
| E10 | 42 | 18 | 14.5 | 23 | 2.5 | 0.03 | 2 | 0.65 | 0.05 | 4.5 |
| E11 | 42 | 18 | 14.5 | 23 | 2.5 | 0.03 | 2 | 0.65 | 0.05 | 4.5 |
| E12 | 42 | 18 | 14.5 | 23 | 2.5 | 0.03 | 2 | 0.65 | 0.05 | 4.5 |
| E13 | 42 | 18 | 14.5 | 23 | 2.5 | 0.05 | 2 | 0.65 | 0.05 | 4.5 |
| E14 | 42 | 18 | 14.5 | 23 | 2.5 | 0.05 | 2 | 0.65 | 0.05 | 4.5 |
| E15 | 42 | 18 | 14.5 | 23 | 2.5 | 0.05 | 2 | 0.65 | 0.05 | 4.5 |
| E16 | 42 | 18 | 14.5 | 23 | 2.5 | 0.04 | 3 | 0.60 | 0.07 | 4.5 |
| E17 | 42 | 18 | 14.5 | 23 | 2.5 | 0.04 | 3 | 0.60 | 0.07 | 4.5 |
| E18 | 42 | 18 | 14.5 | 23 | 2.5 | 0.04 | 3 | 0.60 | 0.07 | 4.5 |

TABLE 11
Adhesive Layer Formation

| | | Total UV dose |
|---|---|---|
| Ex | Composition | (milliJoules/cm²) |
| E10A | E10 | 1020 |
| E11A | E11 | 756 |
| E12A | E12 | 1120 |
| E13A | E13 | 1020 |
| E14A | E14 | 756 |
| E15A | E15 | 1120 |
| E16A | E16 | 1020 |
| E17A | E17 | 756 |
| E18A | E18 | 1120 |

TABLE 12
Adhesive Layer Testing

| | | Surface | | | |
|---|---|---|---|---|---|
| | Adhesive | Resistivity | | | |
| | thickness | Pre UV | Tg | G′ | |
| Ex | (μm) | (ohms/square) | (° C.) | (kPa) | Tan Delta |
| CE10A | 100 | >10 × 10¹² | 0.33 | 190 | 0.64 |
| E10A | 100 | 6.1 × 10⁹ | −2.70 | 137 | 0.77 |
| E11A | 100 | 8.5 × 10⁸ | −1.32 | 142 | 0.77 |
| E12A | 100 | 7.2 × 10⁸ | −2.24 | 140 | 0.77 |
| E13A | 100 | 9.4 × 10⁸ | −2.74 | 144 | 0.75 |
| E14A | 100 | 1.0 × 10⁹ | −1.39 | 155 | 0.74 |
| E15A | 100 | 8.7 × 10⁸ | −2.46 | 138 | 0.74 |
| E16A | 100 | 7.2 × 10⁸ | −2.85 | 138 | 0.70 |
| E17A | 100 | 6.1 × 10⁹ | −2.11 | 148 | 0.69 |
| E18A | 100 | 8.5 × 10⁸ | −1.37 | 141 | 0.68 |

TABLE 13
Optical Performance

| | | Initial | | | | | 500 hours Aging | | | | |
|---|---|---|---|---|---|---|---|---|---|---|---|
| Aging | Ex. | T(%) | H(%) | L | a* | b* | T(%) | H(%) | L | a* | b* |
| 85/85 | CE10A | 91.8 | 0.11 | 96.4 | −0.47 | 0.26 | 91.3 | 0.46 | 95.8 | −0.38 | 0.59 |
| | E11A | 91.7 | 0.16 | 96.4 | −0.55 | 0.47 | 91.3 | 0.34 | 95.8 | −0.57 | 1.21 |
| | E14A | 91.9 | 0.07 | 96.5 | −0.57 | 0.43 | 91.7 | 0.14 | 96.1 | −0.54 | 0.83 |
| | E17A | 91.8 | 0.11 | 96.5 | −0.57 | 0.45 | 91.6 | 0.20 | 96.1 | −0.60 | 0.94 |
| QUV | CE10A | 91.8 | 0.12 | 96.4 | −0.48 | 0.26 | 91.6 | 0.13 | 96.2 | −0.41 | 0.39 |
| | E11A | 91.7 | 0.09 | 96.4 | −0.57 | 0.47 | 91.4 | 0.11 | 96.2 | −0.49 | 0.81 |
| | E14A | 91.9 | 0.08 | 96.5 | −0.53 | 0.44 | 91.6 | 0.11 | 96.2 | −0.49 | 0.83 |
| | E17A | 91.8 | 0.08 | 96.4 | −0.56 | 0.45 | 91.5 | 0.12 | 96.2 | −0.53 | 0.97 |

### Examples E19-E21 and Comparative Example CE11A

A series of adhesive samples were prepared using the compositions of Table 14 in parts by weight to determine the effect of varying the level of IBOA and the addition of nanoparticles. The compositions were coated and cured to form adhesive layers, the coating conditions are shown in Table 15. The Tg and modulus were measured. These data are shown in Table 16.

TABLE 14
Adhesive Compositions

| | 2- | 2- | 2- | | | | | Initiator- | | | Antistat- |
|---|---|---|---|---|---|---|---|---|---|---|---|
| Ex | EHA | EHMA | HEA | IBOA | ACM | HDDA | ABP | 1 | Silane | NP | 2 |
| CE11A | 42 | 18 | 14.5 | 23 | 2.5 | 0.03 | 2 | 0.45 | 0.03 | 0 | 4.5 |
| E19 | 37.5 | 16 | 13 | 31 | 2.5 | 0.03 | 2 | 0.6 | 0.03 | 0 | 4.5 |
| E20 | 40 | 17 | 13.5 | 27 | 2.5 | 0.05 | 2 | 0.65 | 0.05 | 0 | 4.5 |
| E21 | 42 | 18 | 14.5 | 23 | 2.5 | 0.04 | 3 | 0.60 | 0.04 | 11 | 4.5 |

TABLE 15
Coating Conditions for Examples E19-E21

| | | E19 | E20 | E21 |
|---|---|---|---|---|
| Zone 1 | mW/cm2 | 3 | 3 | 3 |
| intensity | | | | |
| Zone 1 time | second | 80 | 80 | 80 |
| Zone 2 | mW/cm2 | 9 | 9 | 9 |
| intensity | | | | |
| Zone 2 time | second | 80 | 80 | 80 |
| total dosage | mJ/cm2 | 960 | 960 | 960 |

TABLE 16
Rheological Data

| | | | Tan |
|---|---|---|---|
| | Tg | G′@25 C. | Delta |
| | (° C.) | (kPa) | @70° C. |
| CE11A | 0.28 | 181 | 0.68 |
| E19 | 4.08 | 236 | 0.75 |
| E20 | 0.63 | 181 | 0.74 |
| E21 | −6.10 | 135 | 0.74 |

What is claimed is:

1. An antistatic pressure sensitive adhesive comprising:
a (meth)acrylate-based optically clear pressure sensitive adhesive matrix that is the product of a reaction mixture comprising:
at least one alkyl (meth)acrylate, wherein the alkyl group has 4 to 18 carbon atoms;
at least one hydrophilic copolymerizable monomer;
at least one crosslinking monomer;
at least one photo-activated crosslinker; and
a free-radical generating initiator; and
at least one antistatic agent;
wherein the antistatic pressure sensitive adhesive is optically clear having a visible light transmission of at least 90% and a haze of less than 1%, has a 180° Peel Adhesion on glass of at least 0.77 N/mm, and a Surface Resistance of from 10⁸-10¹⁰ ohms/cm².

2. The antistatic pressure sensitive adhesive of claim 1, wherein the antistatic agent comprises a quaternary alkyl ammonium sulfonimide of general formula 1: 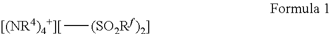
wherein R⁴ is an alkyl group with 1-6 carbon atoms; and
R^{f} is fluorinate alkyl group with 1-4 carbon atoms.

3. The antistatic pressure sensitive adhesive of claim 2, wherein the R^{f} groups are perfluorinated methyl groups.

4. The antistatic pressure sensitive adhesive of claim 1, wherein the reaction mixture comprises: 60-95 parts by weight of alkyl (meth)acrylate monomer(s);
5-40 parts by weight hydrophilic copolymerizable monomer(s);
0.01-0.05 parts by weight of crosslinking monomer;
1-5 parts by weight of photo-activated crosslinker; and
0.05-2 parts by weight of free-radical generating initiator.

5. The antistatic pressure sensitive adhesive claim 1, wherein the alkyl (meth)acrylate monomer(s) comprise: 2-ethylhexyl (meth)acrylate, isobornyl (meth)acrylate, iso-octyl (meth)acrylate, butyl (meth)acrylate, and mixtures thereof.

6. The antistatic pressure sensitive adhesive of claim 1, wherein the hydrophilic copolymerizable monomer(s) comprise: (meth)acrylic acid, 2-hydroxyethyl (meth)acrylate, hydroxypropyl (meth)acrylate, ethoxyethoxyethyl (meth)acrylate, (meth)acrylic amide, diacetone (meth)acrylamide, N, N-dimethyl(meth)acrylamide, and N-morpholino (meth)acrylate, or combinations thereof.

7. The antistatic pressure sensitive adhesive of claim 1, wherein the antistatic pressure sensitive adhesive has a storage modulus (G′) of greater than 100 kilo Pascals at 25° C.

8. The antistatic pressure sensitive adhesive of claim 1, wherein the antistatic pressure sensitive adhesive comprises 2-12% by weight of the antistatic agent based on the total dry weight of the antistatic pressure sensitive adhesive.

9. The antistatic pressure sensitive adhesive of claim 1, further comprising at least one additive.

10. A laminate article comprising:
a first substrate;
a second substrate; and
an antistatic pressure sensitive adhesive disposed between the first and second substrates, wherein the antistatic pressure sensitive adhesive comprises:
a (meth)acrylate-based optically clear pressure sensitive adhesive matrix that is the product of a reaction mixture comprising:
at least one alkyl (meth)acrylate, wherein the alkyl group has 4 to 18
carbon atoms;
at least one hydrophilic co-polymerizable monomer;
at least one crosslinking monomer;
at least one photo-activated crosslinker; and
a free-radical generating initiator; and
at least one antistatic agent;
wherein the antistatic pressure sensitive adhesive is optically clear having a visible light transmission of at least 90% and a haze of less than 1%, has a 180° Peel Adhesion on glass of at least 0.77 N/mm, and a Surface Resistance of from 10⁸-10¹⁰ ohms/cm².

11. The laminate article of claim 10, wherein at least one of the first and second substrates is substantially transparent.

12. The laminate article of claim 10, wherein at least one of the first and second substrates are optically clear.

13. A method of preparing an article comprising:
providing a first substrate with a first major surface and a second major surface;
providing a second substrate with a first major surface and a second major surface; and
preparing an antistatic pressure sensitive adhesive or a pressure sensitive adhesive precursor mixture,
disposing the antistatic pressure sensitive adhesive or pressure sensitive adhesive precursor mixture on at least a portion of the second major surface of the first substrate to form an adhesive layer;
disposing the second substrate on the adhesive layer;
wherein the antistatic pressure sensitive adhesive is optically clear having a visible light transmission of at least 90% and a hze of less than 1%, has a 180° Peel Adhesion on glass of at least 0.77 N/mm, and a Surface Resistance of from 10⁸-10¹⁰ ohms/cm².

14. The method of claim 13, wherein preparing the antistatic pressure sensitive adhesive comprises:
providing a reaction mixture comprising:
at least one alkyl (meth)acrylate, wherein the alkyl group has 4 to 18 carbon atoms;
at least one hydrophilic copolymerizable monomer;
at least one crosslinking monomer;
at least one photo-activated crosslinker; and
a free-radical generating initiator; and
at least one antistatic agent; and
curing the reaction mixture;

15. The method of claim 14, wherein the at least one antistatic agent is added after curing the reaction mixture.

16. The method of claim 13, further comprising photocrosslinking the adhesive layer by exposure to actinic radiation.

17. The method of claim 13, wherein the pressure sensitive adhesive precursor mixture comprises:
at least one alkyl (meth)acrylate, wherein the alkyl group has 4 to 18 carbon atoms;
at least one hydrophilic copolymerizable monomer;
at least one crosslinking monomer;
at least one photo-activated crosslinker;
a free-radical generating initiator; and
at least one antistatic agent; and
curing the precursor mixture that is disposed on the second major surface of the first substrate to form the adhesive layer.

18. The method of claim 17, further comprising:
prior to disposing the pressure sensitive adhesive precursor mixture onto the second major surface of the first substrate, partially polymerizing the precursor mixture to form a coatable syrup; and
adding additional free radical generating initiator to the coatable syrup.

19. The method of claim 17, wherein the free radical generating initiator comprises a photoinitiator.
